(19) United States
(12) Patent Application Publication
(10) Pub. No.: US 2020/0158075 A1
(43) Pub. Date: May 21, 2020

(54) HYDROPOWER PLANT FOR CONTROLLING GRID FREQUENCY AND METHOD OF OPERATING SAME

(71) Applicant: VOITH PATENT GMBH, HEIDENHEIM (DE)

(72) Inventors: THOMAS FOITZIK, NEULER (DE); MARTIN BRUNS, HEIDENHEIM (DE)

(21) Appl. No.: 16/604,891

(22) PCT Filed: Mar. 29, 2018
(86) PCT No.: PCT/EP2018/058114

§ 371 Date: Oct. 11, 2019

(30) Foreign Application Priority Data
Apr. 13, 2017 (DE) 10 2017 107 992.0

(51) Int. Cl. F03B 13/08; H02K 7/18; H02K 11/04; H02P 9/02

(52) U.S. Cl. CPC F03B 13/08; H02P 9/02; H02K 11/046; H02K 7/1823

(57) ABSTRACT

A hydropower plant for regulating the frequency of an electric grid has an upper water reservoir; a lower water reservoir; a waterway that connects the upper water reservoir with the lower water reservoir. A turbine that is arranged in the waterway includes a runner, a guide vane apparatus and a device for blowing out the runner space. An electric synchronous machine is mechanically connected to the turbine and a frequency converter is electrically connected to the synchronous machine. A mains transformer is electrically connected to the frequency converter and the mains grid. A resistor is connected in a DC intermediate circuit of the frequency converter in such a way that it may connect the line sections of the DC intermediate circuit to one another. The assembly also includes a device for cooling the resistor.

The present invention relates to a hydropower plant suitable for rapidly controlling the grid frequency, and to a method for operating such a hydropower plant.

Due to the inertia of the water column and the maximum and minimum permissible water pressure in the waterways and turbine, classical hydropower plants may only control electrical power relatively slowly—typically on a timescale of 10-30 seconds. This is not sufficient to contribute to short-term control of the grid frequency in view of increased requirements. For example, the National Grid Code of Great Britain requires that a certain electrical power must be applied to the mains grid or absorbed in less than a second, depending on the grid frequency, in order to participate in the corresponding compensation. The object of the present invention is to provide a hydropower plant that may provide control power on a timescale of less than one second. Another object of the present invention is to provide a method for operating such a hydropower plant.

The inventors have recognized that the specified objective may be accomplished by a hydropower plant with the features of Claim 1. Advantageous embodiments are set forth in the dependent claims that depend from Claim 1. The method according to the invention for operating such a hydropower plant is set forth in the independent method claim. Advantageous embodiments are set forth in the dependent method claims

The solution according to the invention is explained below with reference to the drawings. The drawings illustrate the following, specifically:

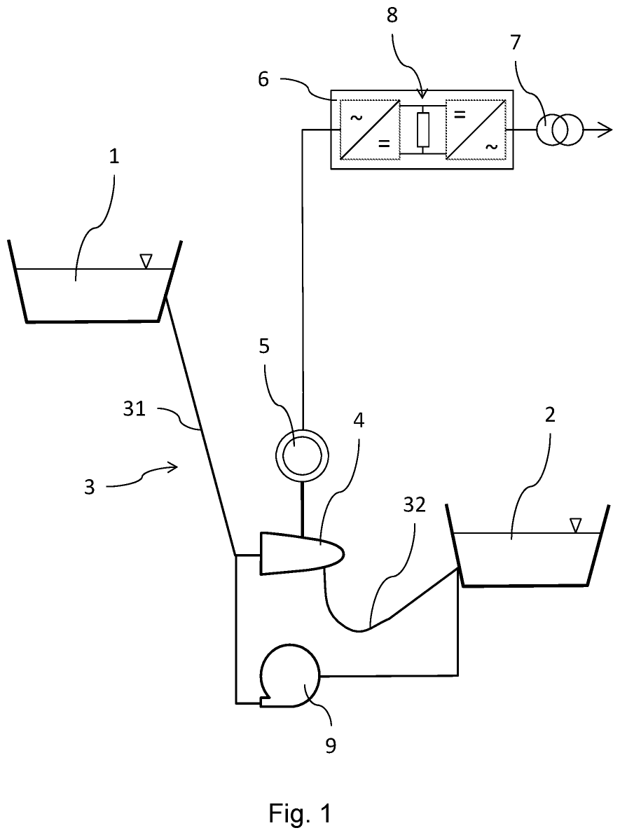

FIG. 1 Hydropower plant according to the invention;

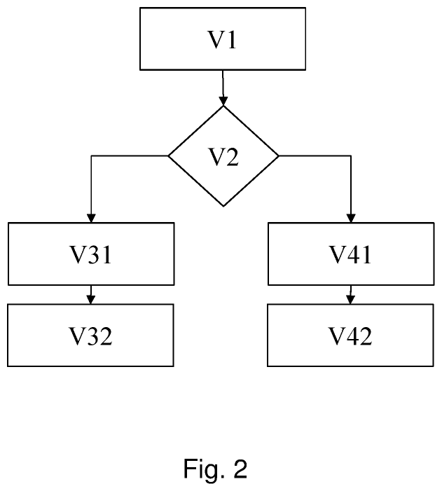

FIG. 2 Flow chart of the operation of a hydropower plant according to the invention.

FIG. 1 shows the schematic structure of a hydropower plant according to the invention. The hydropower plant comprises an upper water reservoir marked 1 and a lower water reservoir marked 2, the water surface of the upper water reservoir 1 being above the water surface of the lower water reservoir 2. The reservoirs 1 and 2 may also be natural waters, for example lakes or rivers. The hydropower plant also comprises a waterway marked 3 that connects the upper water reservoir 1 with the lower water reservoir 2. A turbine marked 4 is arranged in the waterway 3. The waterway 3 is consequently divided into two parts. The part above the turbine 4—the pressure pipe—is marked 31, and the part below the turbine—the draft pipe—is marked 32. The turbine 4 has a turbine runner, a guide vane apparatus and a device for blowing out the space around the turbine runner so that when blown out the turbine runner may rotate in air, with the closed guide vane apparatus preventing the air from escaping toward the upper water reservoir. The turbine may optionally be equipped with additional closing members, for example a ball valve, in addition to the guide vane apparatus. The turbine 4 is coupled to an electric synchronous machine, marked 5. The electric synchronous machine 5 is electrically connected to a frequency converter marked 6. The frequency converter 6 is connected to the mains grid via a mains transformer marked 7. If necessary, the frequency converter 6 may be taken out of the electrical line between the synchronous machine 5 and the mains transformer 7 via suitable switches and cables, so that the synchronous machine 5 is directly connected to the mains grid via the mains transformer 7. In certain operating states (see below), the power loss from the frequency converter 6 may thus be conserved. FIG. 1 does not show these switches and lines. There is a resistor in the DC intermediate circuit of the frequency converter 6 that may be switched in such a way that it connects the line sections of the DC intermediate circuit with each other. The resistor is marked with 8. The hydropower plant also optionally comprises at least one pump that is marked with 9 and is arranged to pump water from the lower water reservoir 2 into the upper water reservoir 1. The pump 9 may comprise its own closing members and has its own independent drive with a mains connection.

FIG. 2 shows a schematic flowchart method according to the invention for operating a hydropower plant according to the invention. In the step marked V1, the hydropower plant is in the following state: The runner of the turbine 4 is blown out so that it may rotate in air. The synchronous machine 5 runs in phase-shifter mode, i.e. the rotor thereof rotates according to the grid frequency (i.e. at nominal speed) and, depending on the excitation state, reactive power may be supplied to the mains grid either capacitively or inductively. Due to the coupling of the synchronous machine 5 and the turbine 4, the runner of the turbine 4 rotates at the same rotational speed as the rotor of the synchronous machine 5. In this operating state, the frequency converter 6 may be disconnected from the connection between the synchronous machine 5 and the mains transformer 7. In the step marked V2, a request is sent to the hydropower plant to actively provide fast control power. The request may be to quickly deliver power to the grid or to quickly receive power from the grid. In the first case, the steps on the left branch of the flow chart are followed; in the second case the steps on the right branch are followed.

Power output to the mains grid: In the step marked V31, the frequency converter 6 is switched on, if applicable, and then brakes the synchronous machine 5 and connected turbine 4. The energy stored in the angular momentum of the rotating components is absorbed by the frequency converter 6 and transferred to the mains grid. The procedures that take place in step V31 are very fast and therefore the requested power may be delivered to the mains grid in less than one second. In the step marked V32, the guide vane apparatus is opened, together with other closing members of the turbine 4 if applicable. This allows water to enter the previously blown-out area around the runner of the turbine 4 from the upper water 1. The air is expelled in the direction of the lower water reservoir 2. The water flow accelerates the turbine 4 and synchronous machine 5 back to nominal speed; as a result, power may be durably output to the mains grid. The procedures of step V32 are initiated simultaneously with the procedures of step V31. However, because the procedures of step V32 are much slower than those of step V31, they only become effective much later—usually after approximately 15-20 seconds. Before this, the power output to the mains grid is determined by the procedures of step V31. In step V31, the power output to the mains grid is controlled by the frequency converter 6 and in step V32 by the controller of the turbine 4 with the aid of the guide vane apparatus. In step V32, the frequency converter 6 may be disconnected from the electrical connection between the synchronous machine 5 and mains transformer 7, if applicable, once power output to the mains grid has been completely effected in the turbine operation that the guide vane apparatus controls.

Power absorption from the mains grid: In the step marked V41, the frequency converter 6 is switched on, if applicable, and draws power from the mains grid. This power is converted into heat via the resistor 8. For this purpose, the resistor 8 must be cooled. It is advantageous if part of the power drawn from the mains by the frequency converter 6 is used to accelerate the synchronous machine 5 and the runner of the turbine 4. Thus less energy needs to be converted into heat in the resistor 8. The procedures in step V41 are very fast and therefore the required power may be absorbed from the mains grid in less than one second. The procedures described in step V41 may in principle be used by themselves to absorb power from the mains grid over a longer period of time alone. However, energy is constantly converted into heat and thus, as it were, destroyed. It is accordingly advantageous if the energy is only briefly converted into heat in V41. In the optional step marked V42, the optional pump 9 is started up in order to pump water from the lower water reservoir 2 to the upper water reservoir 1. As a result, additional power is absorbed from the mains grid and the energy that the pump 9 absorbs is converted into potential energy of the water and stored for later use in turbine operation. The procedures of step V42, in this case, are initiated simultaneously with the procedures of step V41. Because the procedures of step V42 are much slower than those of step V41, however, these procedures take longer to come to bear —usually after approximately 10 to 15 seconds. Before this, the power absorption from the mains grid is determined by the procedures of step V41. In step V41, the frequency converter 6 controls power absorption from the mains grid. In step V42, power absorption from the mains grid may be controlled in two ways: Either the pump 9 has a variable speed drive that is able to control the power that the pump 9 absorbs, or the pump 9 is designed as a constant speed pump. In the latter case, the guide vane apparatus of the turbine 5 controls the power absorbed from the mains grid. For this purpose, the guide vane apparatus is opened, together with additional closing members of the turbine 4 if applicable, and the turbine is run in a controlled turbine operation mode. The synchronous machine 5 produces a corresponding electrical power that is fed into the mains grid. The result is a situation known as a hydraulic short circuit. The net power that the mains grid absorbs is then calculated from the pump power minus the power that the synchronous machine 5 produces. Plainly, in this case, the power that the synchronous machine 5 generates must be less than the pump power. Because the guide vane apparatus of the turbine 4 is able to control the turbine power and thus the power that the synchronous machine 5 generates, the net power absorption from the mains grid may also be controlled. In step V42, the frequency converter 6 may be disconnected from the electrical connection between the synchronous machine 5 and the mains transformer 7, if applicable, once the absorption of power from the mains grid has been completely effected by the controlled pump operation as described above.

After processing the request made in step V2 to provide fast control power, the hydropower plant is returned to the operating state described in step V1. The hydropower plant is then once again ready to respond to another request.

Practical experience in designing a hydropower plant according to the invention has shown that it is advantageous if in step V31 the synchronous machine 5 is braked to as much as 50% of the nominal speed. It is also advantageous if in step V41 the synchronous machine 5 is accelerated to as much as 120% of the nominal speed. The frequency converter 6 may be designed as a “Voltage Source Inverter” (VSI). A VSI has the advantage that it enables power factor control as well as control in what is referred to as “Low Voltage Ride Through.” The frequency converter 6 may also be designed as a “Load Commutated Inverter” (LCI). Such an inverter is characterized by low production costs.

In order for the hydropower plant to be able to optimally provide control power as the Grid Code requires, the plant must be designed in such a way that the capacity for power output to the mains grid corresponds to the capacity for power absorption from the mains grid. This requirement must be met over both the short and the long term. The design of the hydropower plant according to the invention is sufficiently flexible that this requirement may be met by an appropriate design of the components.

1-15. (canceled)

16. A hydropower plant for regulating a frequency of an electric grid, the hydropower plant comprising:
an upper water reservoir and a lower water reservoir, wherein a water level of the upper water reservoir lies above a water level of the lower water reservoir;
a waterway hydraulically connecting the upper water reservoir with the lower water reservoir;
a turbine arranged in the waterway, the turbine including a runner, a guide vane apparatus and a device for blowing out a runner space;
an electric synchronous machine mechanically connected to the turbine;
a frequency converter electrically connected to the synchronous machine, the frequency converter having a DC intermediate circuit;
a mains transformer electrically connected to the frequency converter and the mains grid;
a resistor arranged in the DC intermediate circuit of the frequency converter and configured to connect line sections of the DC intermediate circuit to one another; and
a device for cooling the resistor.

17. The hydropower plant according to claim 16, further comprising a pump for pumping water from the lower water reservoir into the upper water reservoir, the pump having an independent drive.

18. The hydropower plant according to claim 16, comprising switches and lines that are arranged to connect the synchronous machine directly to the mains transformer in a first switching state and to connect the synchronous machine to the mains transformer via the frequency converter in a second switching state.

19. The hydropower plant according to claim 17, wherein the pump comprises a variable-speed drive.

20. The hydropower plant according to claim 17, wherein the pump comprises a drive with constant speed.

21. The hydropower plant according to claim 16, wherein the frequency converter is a voltage source inverter (VSI).

22. The hydropower plant according to claim 16, wherein the frequency converter is a load commutated inverter (LCI).

23. A method for operating a hydropower plant, the method comprising: providing a hydropower plant according to claim 16;
in a step V1, blowing out the runner of the turbine and running the synchronous machine in phase-shifter mode;
in a step V2, receiving a request for the hydropower plant to provide fast control power, and:
if power output is requested:
in a step V31, braking the synchronous machine with the frequency converter;
in a step V32, opening the guide vanes of the turbine and starting controlled turbine operation;
if power absorption is requested:
in a step V41, absorbing with the frequency converter power from the mains grid and causing the resistor to convert energy into heat.

24. The method according to claim 23, further comprising, if power absorption is requested: in a step V42, starting the pump and starting controlled pump operation.

25. The method according to claim 23, which comprises providing a hydropower plant according to claim 18 and:
operating the hydropower plant in the first switching state during the following steps: V1, V2, V32 in the state of controlled turbine operation, and V42 in the state of controlled pump operation; and
operating the hydropower plant in the second switching state in steps V31 and V41.

26. The method according to claim 23, wherein step V41 comprises accelerating the synchronous machine by the frequency converter.

27. The method according to claim 23, wherein step V31 comprises braking the synchronous machine to 50% of a nominal speed.

28. The method according to claim 23, wherein step V41 comprises accelerating the synchronous machine by the frequency converter to 120% of a nominal speed.

29. The method according to claim 24, which comprises providing a hydropower plant with a pump having a variable-speed drive and controlling pump operation with the variable speed pump drive in step V42.

30. The method according to claim 24, which comprises providing a hydropower plant with a pump having a constant speed drive and, in step V42, opening the guide vane apparatus of the turbine and controlling the controlled pump operation in step V42 by the guide vane apparatus of the turbine, wherein the turbine and the pump are in a hydraulic short circuit.
